(19) United States
(12) Patent Application Publication
(10) Pub. No.: US 2016/0311467 A1
(43) Pub. Date: Oct. 27, 2016

(54) I-BEAM WITH REINFORCED SKIN

(71) Applicant: CONTINENTAL STRUCTURAL PLASTICS INC., Auburn Hills, MI (US)

(72) Inventor: CHRISTOPHER JOHNSTON, PETOSKEY, MI (US)

(21) Appl. No.: 15/102,911

(22) PCT Filed: Dec. 10, 2014
(86) PCT No.: PCT/US14/69546

§ 371 Date: Jun. 9, 2016

Related U.S. Application Data
(60) Provisional application No. 61/914,113, filed on Dec. 10, 2013.

(51) Int. Cl. B62D 21/15; B32B 5/02; B32B 27/36; B62D 29/04; B32B 27/38

(52) U.S. Cl. CPC B62D 21/15; B62D 29/041; B32B 27/38; B32B 27/36; B32B 5/024; B32B 2323/10; B32B 2262/101; B32B 2262/106; B32B 2605/00

(57) ABSTRACT

An I-beam assembly is provided including a top and bottom flange joined by a vertical web. Reinforcing skins are overmolded over said top and bottom flanges. The top and bottom flanges and the web are all made of the same thermoplastic polymer material or thermoset polymer material. Polymer materials operative herein include polypropylene, nylon, epoxy, polyester, or vinyl ester materials.

### RELATED APPLICATIONS

This application claims priority benefit of U.S. Provisional Application Ser. No. 61/914,113 filed Dec. 10, 2013; the contents of which are hereby incorporated by reference.

### FIELD OF THE INVENTION

The present invention in general relates to composites and in particular to a composite I-beam structure with continuous fiber skins on the tension and compression sides of the I-beam and over-molding of a short fiber material to the continuous fiber skins.

### BACKGROUND OF THE INVENTION

Weight savings in the auto, transportation, and logistics based industries has been a major focus in order to make more fuel efficient vehicles both for ground and air transport. In order to achieve these weight savings, light weight composite materials have been introduced to take the place of metal structural and surface body components and panels. Composite materials are materials made from two or more constituent materials with significantly different physical or chemical properties, that when combined, produce a material with characteristics different from the individual components. The individual components remain separate and distinct within the finished structure. A composite material may be preferred for many reasons: common examples include materials which are stronger, lighter, or less expensive when compared to traditional materials.

Structural automotive components are designed to protect vehicle occupants in high speed accidents by absorbing and dissipating kinetic energy. Structural components such as side intrusion beams in vehicle doors protect occupants during collisions. Structural automotive components are also designed to minimize damage to the vehicle in low speed collisions by absorbing the kinetic energy by temporally deforming or deflecting. I-Beams (also known as H-beams) are a common structural component found in automotive structural applications. The name I-beam or H-beam steams from the cross-section shape that is in an “I” or “H”. The horizontal elements of the I-beam are referred to as flanges, while the vertical or center element connecting the flanges is referred to as the web. The web resists shear forces, while the flanges resist most of the bending moment experienced by the beam. The I-shaped section is a very efficient form for carrying both bending and shear loads in the plane of the web. However, the cross-section has a reduced capacity in the transverse direction, and is also inefficient in carrying torsion. In order to improve the torsional performance of an I-beam, ribs may be added between the web and flanges

While composite materials have been used to form I-beams in structural automotive components and applications, these I-beams have experienced separation of the beam during high speed impact. Furthermore, a shortcoming of the previous beams which relied exclusively upon short fiber composite materials is that they broke in half during such impacts. Thus, there exists a need for an improved composite I-beam that maintains integrity during high speed vehicle accidents.

### SUMMARY OF THE INVENTION

An I-beam assembly is provided including a top and bottom flange joined by a vertical web. Reinforcing skins are overmolded over said top and bottom flanges. The top and bottom flanges and the web are all made of the same thermoplastic polymer material or thermoset polymer material. Polymer materials operative herein include polypropylene, nylon, epoxy, polyester, or vinyl ester materials.

### BRIEF DESCRIPTION OF THE DRAWINGS

FIG. 1A is a side perspective view of an I-beam composite structure with continuous fiber skins on the tension and compression sides of the I-beam with an over-molding of a short fiber material applied to the continuous fiber skins according to an embodiment of the invention;

FIG. 1B is a cross-section view along line A-A of FIG. 1A according to embodiments of the invention; and

FIG. 2 is a side perspective view of a curved I-beam designed to deflect and absorb kinetic energy on impact according to an embodiment of the invention

### DETAILED DESCRIPTION OF THE INVENTION

The present invention has utility as an improved composite I-beam structure with continuous fiber reinforcing skins on the tension and compression sides of the I-beam, and an over-molding of a short fiber material applied to the continuous fiber skins to improve the structural integrity of the I-beam. Embodiments of the inventive I-beam composite structure are formed with thermoplastic polymers including polypropylene, nylons, etc.; thermoset polymers such as epoxy, a polyester, or a vinyl ester material; as well as thermoset resins. The flanges, web, and ribs of embodiments of the inventive I-beam are impregnated with chopped fibers such as glass, carbon, and other synthetic fibers, as well as natural fibers. Natural fibers may include coconut fibers, bamboo fibers, sugar cane fibers, banana skin fibers, etc. In certain embodiments of the inventive I-beam, the web may also be formed with continuous fibers. The ribs of embodiments of the inventive I-beam connect between the web and flanges and may be in various patterns such as crosses. Embodiments of the inventive I-beam are formed using injection molding; however, it is anticipated that compression molding, resin transfer molding, or other techniques could also be employed. Non-limiting examples of applications for the inventive I-beam include bumper systems, and side impact intrusion beams.

The continuous fiber reinforcing skins that are applied to the flanges may have unidirectional fibers, bi-axial fibers, woven fibers, or consist of laminates composed of different combinations of fiber patterns. In certain embodiments, reinforcement of the I-beam flanges are with prepreg composites. Prepreg, also described as organic sheet when applied to thermoplastic resin formats, are defined as continuous unidirectional-fiber in tape format or fabrics of bi-axial or woven fibers pre-impregnated with thermoplastic or thermoset resins. The thermoplastic versions can be heated until soft and placed in a mold, where they are formed and overmolded in selected areas with additional resin to add ribs, attachment points, etc. A prepreg is typically formed as individual layers of a substrate saturated with a thermoplastic or thermoset resin in sheets or rolls. Laminates are typically multiple layers of fiber substrate such as prepreg or organic sheet bonded together with thermoplastic or thermoset resin. Prepreg in some embodiments include reinforcing fibers that include carbon fiber or glass fiber. Matrices for a thermoplastic prepreg illustratively include polyetheretherketone (PEEK), polyetherketoneketone (PEKK), polyetherimide (PEI), polyphenylene sulfide (PPS), polyamide (nylon), polypropylene (PP), combinations thereof and copolymers thereof. Matrices for a thermoset prepreg illustratively include epoxy, polyester (PE), and vinyl ester (VE).

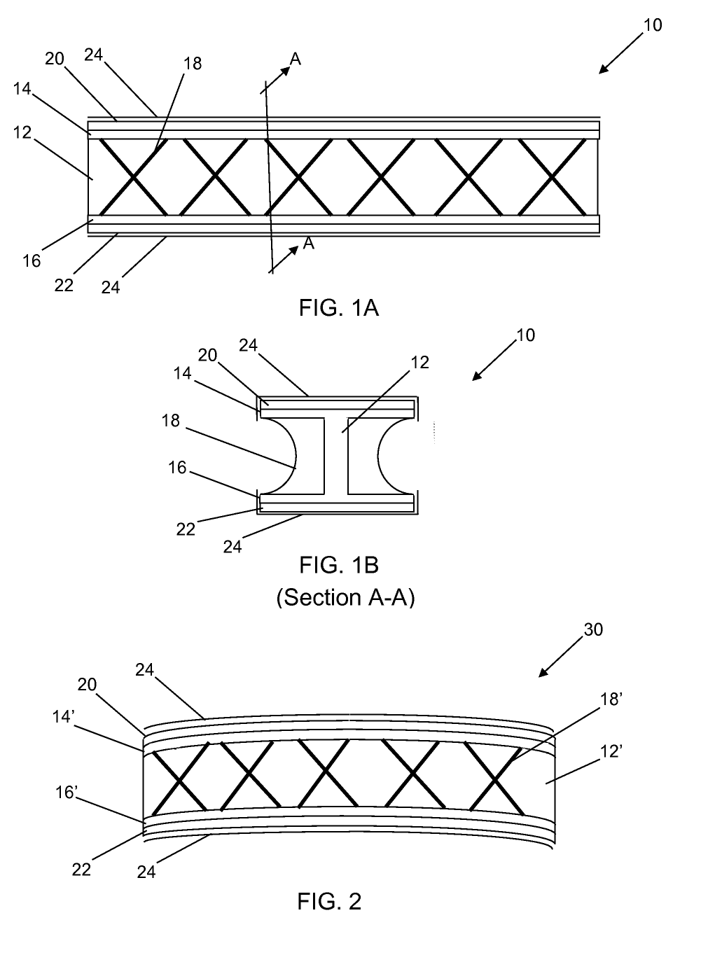

Referring now to the figures, FIG. 1A is a side perspective view of an I-beam 10 composite structure with a web 12 and continuous fiber skins 20 and 22 applied on the tension 14 and compression 16 sides of the flanges of the I-beam 10 with an over-molding 24 of a short fiber material applied to the continuous fiber skins according to an embodiment of the invention. A rib 18 in various patterns including a crossing pattern as shown provides resistance to torsional loads. FIG. 1B is a cross-sectioned view of FIG. 1A along line A-A

FIG. 2 illustrates an embodiment of the inventive I-beam 30 with a slight curvature to the web 12′ and flanges 14′ and 16′ designed to minimize damage to the vehicle in low speed collisions by absorbing the kinetic energy by temporally deforming or deflecting.

The foregoing description is illustrative of particular embodiments of the invention, but is not meant to be a limitation upon the practice thereof. The following claims, including all equivalents thereof, are intended to define the scope of the invention.

1. An I-beam assembly, said assembly comprising:
a top and bottom flange joined by a vertical web;
reinforcing skins overmolded over said top and bottom flanges; and
wherein said top and bottom flange and said web are all made of the same thermoplastic polymer material or thermoset polymer material.

2. The assembly of claim 1 wherein said thermoplastic polymer is at least one of a polypropylene, or a nylon material.

3. The assembly of claim 1 wherein said thermoset polymer material is at least one of an epoxy, a polyester, or a vinyl ester material.

4. The assembly of claim 1 wherein said polymer further comprise chopped fibers.

5. The assembly of claim 3 wherein said chopped fibers are at least one of glass, carbon, or other synthetic fibers.

6. The assembly of claim 3 wherein said chopped fibers are natural fibers.

7. The assembly of claim 5 wherein said natural fibers are at least one of coconut fibers, bamboo fibers, sugar cane fibers, or banana skin fibers.

8. The assembly of claim 1 wherein said reinforcing skins have unidirectional fibers.

9. The assembly of claim 1 wherein said reinforcing skins have bi-axial fibers.

10. The assembly of claim 1 wherein said reinforcing skins have woven fibers.

11. The assembly of claim 1 wherein said reinforcing skins are laminates.

12. The assembly of claim 11 wherein said laminates are combinations of unidirectional, bi-axial, and woven fibers.

13. The assembly of claim 1 further comprising an overmolding of prepreg or organic sheet composites.

14. The assembly of claim 1 reinforcing skins are overmolded with a short fiber material.

15. The assembly of claim 1 wherein said I-beam further comprises a series of ribs in various patterns extending from said web to said bottom and top flanges.

16. The assembly of claim 15 wherein said series of ribs are made of thermoplastic polymer material or thermoset resin that are impregnated with chopped fibers.
